(19) United States
(12) Patent Application Publication
(10) Pub. No.: US 2010/0295770 A1
(43) Pub. Date: Nov. 25, 2010

(54) CONTROL METHOD FOR CONTROLLING REMOTE COMPUTER

(75) Inventor: Jae Bum Shim, Seoul (KR)

Correspondence Address: LRK Patent Law Firm, 1952 Gallows Rd, Suite 200, Vienna, VA, 22182, US

(73) Assignee: LOGICPLANT, Seoul (KR)

(21) Appl. No.: 12/438,531

(22) PCT Filed: Aug. 23, 2007
(86) PCT No.: PCT/KR07/04033

§ 371 Date: Aug. 11, 2010

(30) Foreign Application Priority Data
Aug. 23, 2006 (KR) 10-2006-0080148

(51) Int. Cl. G09G 5/00

(52) U.S. Cl. 345/156

(57) ABSTRACT

The present invention relates to a control method of efficiently controlling a computer at a remote place using a limited input/output device and a remote communication terminal with limited memory capacity even in a communication network environment where the data transmission rate is limited and the transmission cost is high. The control method in accordance with the present invention includes an input method optimized for a limited input device of a terminal, a screen display method optimized for a small screen of a terminal, and a screen data transmission function optimized for a communication network speed, a transmission cost, and a limited memory capacity of a terminal.

### TECHNICAL FIELD

The present invention relates to a control method of efficiently controlling a computer at a remote place using a limited input/output device and a remote communication terminal with limited memory capacity even in a communication network environment where the data transmission rate is limited and the transmission cost is high.

### BACKGROUND ART

Synchronization of use environment can be established between a remote computer and a user terminal through a wired or wireless communication network. In conventional remote control, intact, accurate, and fast synchronization between both parties becomes important. Thus, the screen of the remote computer is displayed on the user terminal in real-time without change, and matters input in the user terminal are applied to the remote computer with no change.

This is because the data transmission rate of the communication network is sufficient high, the data transmission cost is low, and the remote computer and the user terminal have a similar type and performance. An attempt has been made to reduce the amount of data transmitted through the communication network. However, this attempt employs a simple method, such as a reduction in the number of screen colors and data compression between both parties, within a range to fulfill the intact and accurate synchronization conditions. In the case of an input, it is assumed that input devices of both parties are almost similar, but conversion according to the difference between the input devices is not taken into consideration.

Therefore, in the event that the data transmission rate is not sufficiently high, the data transmission cost is high, and there is a difference in the performance of a remote computer and a user terminal and the types of I/O devices, such as a mobile communication network, there is a problem in applying the conventional technology. For example, in conventional remote control, in order to view the screen of the remote computer in the user terminal, changed data are immediately sent to the user terminal whenever the screen content of the remote computer is changed.

However, the mobile communication network is not sufficient enough to send data having a changed transmission rate in real-time. Accordingly, real-time control is difficult, high cost is necessary due to a huge amount of data, and information is wasted because the size of the user terminal screen is too small to display transmitted screen data as an original form. Even in the case of an input, a mobile phone occupying most of the user terminal of the mobile communication network consists of only the numeric buttons and several special buttons, and is thus actually impossible to emulate about 100 keys and the mouse of a general computer keyboard.

### DISCLOSURE OF INVENTION

### Technical Problem

Accordingly, an object of the present invention to provide a control method of efficiently controlling a computer at a remote place using a limited input/output device and a remote communication terminal with limited memory capacity even in a communication network environment where the data transmission rate is limited and the transmission cost is high.

### Technical Solution

To achieve the above object, in accordance with the present invention, there is provided a control method of a system including a user terminal and a remote computer, which are connected to a communication network and can communicate with each other, including the steps of extracting screen data corresponding to a screen displayed on the remote computer, converting the extracted screen data according to a specification of the user terminal, and extracting screen control-related information of an application program that is being executed in the remote computer, allowing the user terminal to receive the converted screen data and the extracted screen control-related information, displaying a screen of the user terminal based on the received converted screen data and the received screen control-related information, receiving user input information on the basis of the displayed screen, and sending the received user input information to the remote computer, and allowing the remote computer to receive the user input information, convert the received user input information according to a specification of the remote computer, and drive a corresponding operation.

The present invention presents an input method suitable for a user terminal, appropriately converts screen data and input data according to a difference in the type and specification between a remote computer and a user terminal, reduces the amount of transmission data and introduces appropriate transmission delay to a level where a user can recognize a screen appropriately. Accordingly, a remote control environment, which operates efficiently in a remote communication terminal with limited I/O devices and memory capacity and a communication network having a limited data transmission rate and a high transmission cost, can be provided.

### ADVANTAGEOUS EFFECTS

In accordance with the present invention, a computer at a remote place can be controlled efficiently using a limited input/output device and a remote communication terminal with limited memory capacity even in a communication network environment where the data transmission rate is limited and the transmission cost is high. Accordingly, a user can perform necessary tasks efficiently by accessing a computer in the office or a computer within a home by using a terminal, such as PDA or a mobile phone, anywhere where communication network access is supported.

### BRIEF DESCRIPTION OF THE DRAWINGS

FIG. 1 is a view illustrating an example of a configuration of a computing environment providing system for a mobile device to which a control method in accordance with the present invention is applied;

FIGS. 2 and 3 are message sequence charts illustrating an operating method of the computing environment providing system for a mobile device shown in FIG. 1;

FIGS. 4 to 6 are views to which reference is made in order to describe the operating method of the computing environment providing system for a mobile device shown in FIG. 1;

FIG. 7 is a view illustrating an input method suitable for a user terminal used in the control method in accordance with the present invention;

FIG. 8 is a view illustrating a method of performing the input of a character string and input object search; and

FIG. 9 is a view illustrating a construction of a screen data cache used in the control method in accordance with the present invention.

### BEST MODE FOR CARRYING OUT THE INVENTION

Hereinafter, the present invention will be described in detail with reference to the drawings.

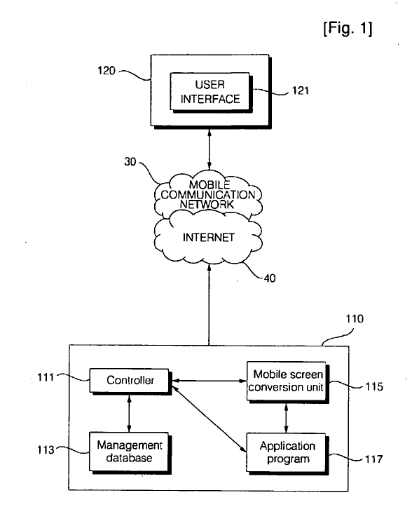

FIG. 1 is a view illustrating an example of a configuration of a computing environment providing system for a mobile device to which a control method in accordance with the present invention is applied. Referring to FIG. 1, a user terminal 120 and a remote computer 110 are connected to each other and communicate with each other through a mobile communication network 30 and an Internet 40. The remote computer 110 includes a general computer or a server installed at a company that provides predetermined services.

The remote computer 110 may include a controller 111, a management database 113, a mobile screen conversion unit 115, and an application program 117. The controller 111 performs user certification using the management database 113, generates and manages a user-based computing environment, controls the operation of the application program 117 according to an operation command received from the user terminal 120, and transfers a mobile screen, which is appropriate for a current state and received from the mobile screen conversion unit 115, to the user terminal 120. In the management database 113 are stored information for user certification and computing environment information of an individual user. The application program 117 is a program performed in a general personal computer, and is the existing general program that is not written or modified separately for the present invention.

The computing environment includes the application program 117 performed within an environment, documents stored by the application program 117, computing environment information such as environment setting information, a screen on which the application program 117 is displayed and/or the like. The computing environment may exist in plural at the same time in the remote computer 110, and respective computing environments existing at the same time are independent from one another.

The computing environment may be irrespective of a user-based account or a terminal function provided by an operating system. In other words, the remote computer 110 can provide a plurality of computing environments using one user account on an operating system and one desktop screen provided when a corresponding account is logged on, instead of a function provided an operating system. In this case, the controller 111 controls a position where a document is stored by the application program 117 or a position where environment setting information is stored to be changed and then stored in the management database 113 unique to a user. Accordingly, plural pieces of computing environment information can coexist using only one user account on the operating system. An example of the method of changing the storage position may include a user programming interface of Windows environment, Hooking, and so on.

The controller 111 may employ a method of logically partitioning a desktop screen in order to provide a plurality of computing environment screens using one desktop screen. In general, since screen resolutions of the user terminal 120 are lower than those of the remote computer 110, the desktop screen of the remote computer 110 is logically partitioned in line with the screen resolutions of the user terminal 120, and a screen displayed on a corresponding user terminal 120 is configured per computing-environment basis using only a corresponding logically partitioned part. For example, assuming that desktop screen resolutions of the remote computer 110 is 1600×1200 and screen resolutions of the user terminal 120 is 320×240, the desktop screen of the remote computer 110 correspond to 25 screens of the user terminal 120. Thus, 25 logical partitions are possible and at least 25 computing environments are made possible.

The application program 117 performed by each user is disposed at a position of a corresponding logical partition of the remote computer (110) screen and is controlled to have a user interface size as much as logical partitions. The mobile screen conversion unit 115 configures a screen for the user terminal 120, which is transferred to a corresponding user, by using only logically partitioned parts allocated to each computing environment. Thus, though the application programs 117, which are being executed in computing environments of a plurality of users, are arranged in a tile form in the desktop screen of an actual remote computer 110, an actual user can see only one tile for his computing environment, that is, only one logical partition. In the event that computing environments having a number larger than the number of possible logical partitions are provided, a method of reallocating a logical partition of a computing environment, which has not been used for the longest time, to a computing environment to which a logical partition has to be allocated at the present time is used. At this time, in the application program 117 of an existing computing environment, a user interface is minimized, the screen disappears, and a user interface of the application program 117 of a new computing environment is disposed in a corresponding logical partition.

The user terminal 120 can communicate with the remote computer 110 through the Internet 40 and the mobile communication network 30, and the user terminal 120 includes a mobile phone, a PDA and so on. The user terminal 120 includes a user interface 121 for controlling a computer environment. The user terminal 120 shows the user interface 121 to a user. If a desired operation is selected, the user terminal 120 transfers a corresponding operation to the remote computer 110 so that the operation is performed. Further, the user terminal 120 receives a state, which is changed according to an operation result, or a state, which is automatically changed in the computing environment of the remote computer 110, and reflects the state on the user interface 121.

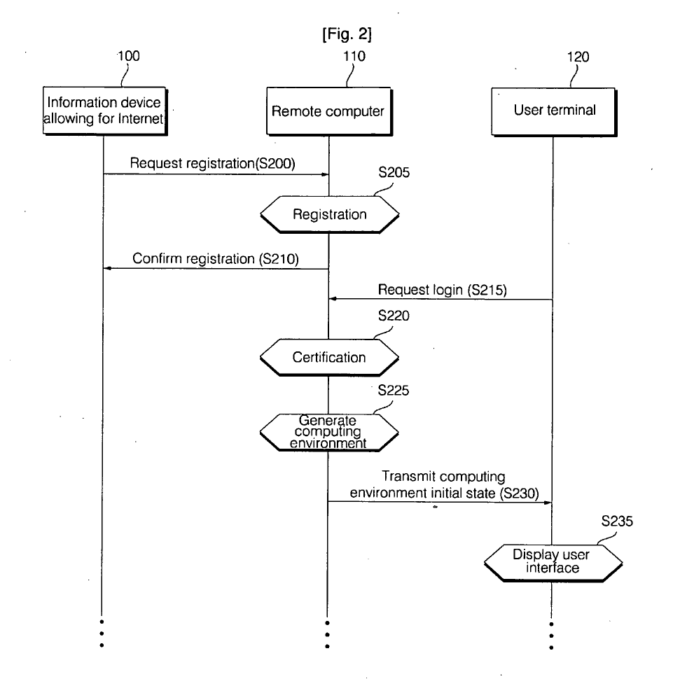

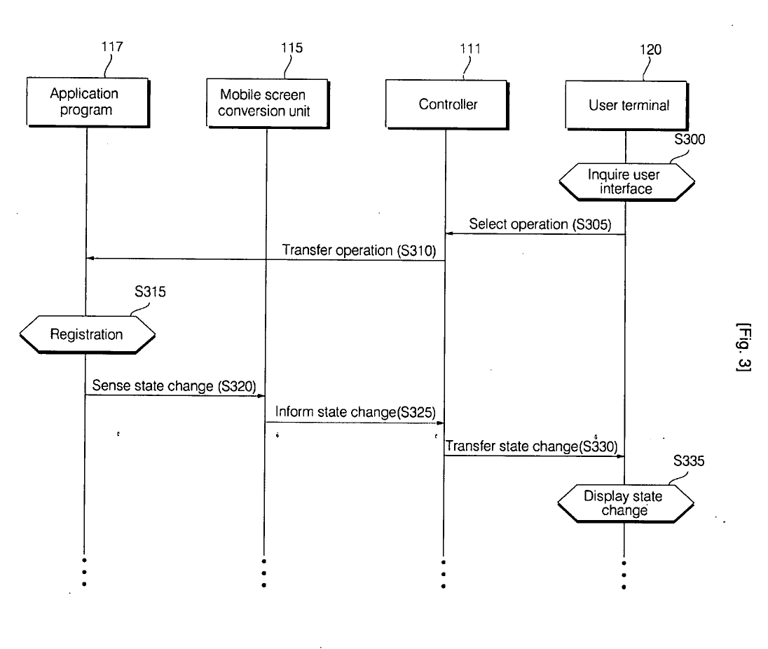

FIGS. 2 and 3 are message sequence charts illustrating an operating method of the computing environment providing system for a mobile device shown in FIG. 1.

FIG. 2 is a message sequence chart for illustrating matters related to initialization, of the method of operating the computing environment providing system for a mobile device. Referring to FIG. 2, a request for a service use is made from the remote computer 110 through an information device that allows for an Internet (S200). A registration process is then performed (S205). The remote computer 110 confirms such registration (S210). At an initial state, a user downloads a program that provides the user interface 121 on the user terminal 120.

Thereafter, the user requests logon in order to use a computing environment in the user terminal 120 (S215). The remote computer 110 performs a corresponding certification procedure (S220), generates a computing environment for a corresponding user (S225), and sends an initial state of the generated computing environment to the user terminal 120 (S230). The user terminal 120 displays the initial state of the computing environment on the user interface along with a menu (S235).

FIG. 3 is a message sequence chart for illustrating matters, which are related to an operation of an actual application program from selection of the operation of the user terminal and the transfer of the operation results, of the method of operating the computing environment providing system for a mobile device. Referring to FIG. 3, the user terminal 120 inquires the user interface 121 displayed on the screen (S300), selects a necessary function, and sends a corresponding operation to the remote computer 110 (S305).

The controller 111 of the remote computer 110 transfers the operation, which is received from the user terminal 120, to the application program 117 (S310). At this time, the operation transfer method may employ Object Link Embedding (OLE) automation, Windows message transmission, a keyboard and mouse simulation, a method of using an Application Programming Interface (API) provided by the application program 14, etc. in the case of the Windows'environment. The application program 117 performs the received operation (S315). At this time, the operation of the application program 117 is the same as that in an existing personal computer. If the state of the application program 117 is changed, the mobile screen conversion unit 115 informs the controller 111 of the fact while continuing to monitor the state of the application program 117 (S320). The mobile screen conversion unit 115 sends mobile screen information and other items, which are changed accordingly, to the controller 111 (S325). The controller 111 sends the received information to the user terminal 120 (S330).

The user terminal 120 displays the received information on the user interface 121 (S335). A state change according to selection of the operation of the user terminal 120 has been illustrated. However, the state of the application program 117 can be changed even without selection of the operation of the user terminal 120. In this case, the mobile screen conversion unit 115 senses a corresponding state change and informs the controller 111 of the fact in the same manner as the case according to selection of the operation.

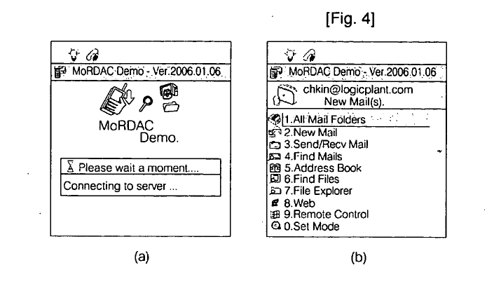

FIGS. 4 to 6 are views to which reference is made in order to describe the method of operating the computing environment providing system for a mobile device shown in FIG. 1.

FIG. 4 is a view illustrating a situation where a user gains access to the remote computer 110 in order to use a computing environment in the user terminal 120. Referring to FIG. 4a, the user gains access to the remote computer 110 by pressing a predetermined key in the user terminal 120. The remote computer 110 sends, to the user terminal 120, an initial state of a computing environment for a corresponding user, which is generated through a certification procedure, such as employing a telephone number when the user terminal 120 is a mobile phone and receiving a password. The user terminal 120 displays an appropriate screen and menu thereon according to received information. A menu available to the user is displayed as shown in FIG. 4b, but the screen of the computing environment can be displayed as in an existing remote control tool.

FIG. 5 is a view illustrating, as an example, a case where a mail application program is used. In FIG. 5, a case where a specific mail folder of a mail function is selected and a mail within the folder is then opened is illustrated. A mail application program of a personal computer has a complicated user interface, which is difficult to use directly in the user terminal 120. In this case, however, an optimized user interface can be provided to a mobile device though a mutual interaction between the mobile screen conversion unit 115 and the user interface 121 of the user terminal 120. A user can confirm new mails by selecting a received mailbox and can open the existing mails by selecting a predetermined mail folder.

In FIG. 5, (a) shows a process of selecting a folder list, (b) shows a process of selecting a mail list view from a selected folder, and (c) shows that a selected mail list is displayed. Further, (d) shows a process of selecting a mail view, and (e) shows that mail contents are displayed.

In the process of selecting the folder or the mail as described above, a menu item of a list form, a menu item of a pop-up form, etc. is used. If the folder or the mail is selected, the user terminal 120 sends corresponding operating information to the remote computer 110. After the mail application program executes an actual operation, the user terminal 120 sends the execution results to the user terminal 120 again. The results executed by the mail application program are displayed on the user interface 121 of the user terminal 120 so that a next operation can be performed.

The content of the mail may be received and displayed in a text form, received and displayed as an image, which is displayed on the screen of a computing environment and then captured by the mail application program, or received by a mobile device as they are and then displayed on a screen as a form similar to an original form. In FIG. 5, (f) shows a process of selecting a mail receiver list, (g) shows a screen where a view is selected as an original format, and (h) shows a screen where the view is executed as an original form. As described above, the remote computer 110 and the user terminal 120 recognize, specify, and process the mail application program. Accordingly, use convenience and efficiency can be improved when compared with an existing remote control tool where a screen is displayed and received simply through the entire screen capture.

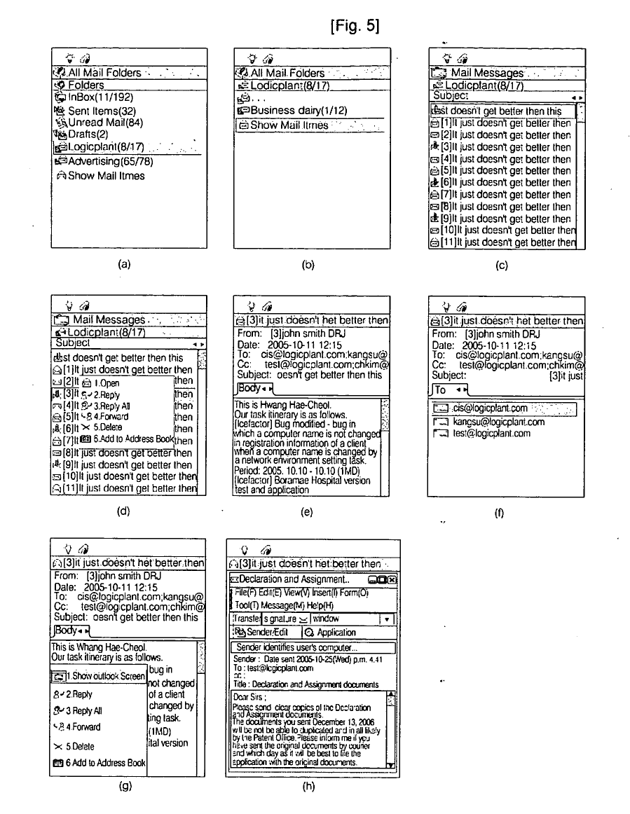

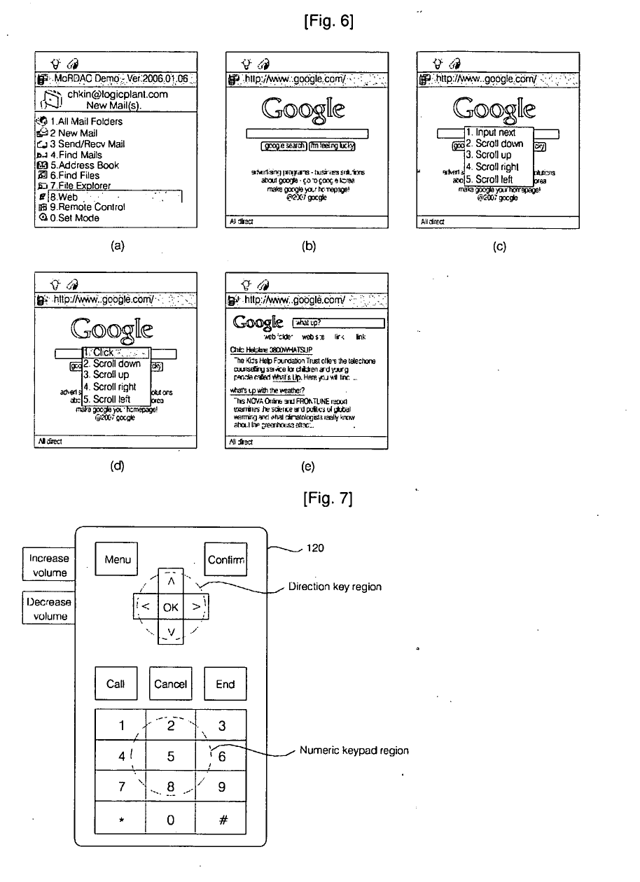

FIG. 6 is a view for illustrating a case where a web browser is used. It can be seen that a web browser screen can show results, close to an original screen operating in a personal computer when compared with the screen of the mail application program, to the screen of the user terminal 20. This is the result of characteristics of information viewing for viewing a screen close to an original screen, and a web browser facilitating screen control, and is an example where the screen is specially processed according to the type of the application program 117. In FIG. 6, (a) shows a process of selecting a web page, (b) shows an example of a start web page, (c) shows a process of inputting a text, and (d) is a process of clicking on a button. Through these processes, a web page moves to a new web page. (e) shows a new web page.

From FIG. 6, it can be seen that an operation of inputting a text and pressing a button is different from that of a personal computer. This is due to the non-existence of a mouse and the characteristic of a mobile device having a limited keyboard input.

As described above, there are a case where a specialized user interface different from the screen of the application program is used and a case where a screen close to an original screen is shown. Of them, the latter case is required to provide a user interface in which the limit of a user terminal can be overcome and the screen can be controlled at a personal computer level. Hereinafter, a providing method thereof is described. This providing method is also partially available for the former case.

FIG. 7 shows an input device of a mobile phone, that is, a terminal generally used in a wireless communication network (that is, a representative low-speed communication network), and illustrates an input method suitable for a user terminal used in the control method in accordance with the present invention. An input device of a general computer is constructed of a keyboard having 100 keys, and a mouse. In a recent operating system, manipulation is largely performed using a mouse aside from a character input. Accordingly, in the present invention, keys of a mobile phone for efficiently supporting mouse manipulation are arranged.

A numeric keypad region is first allocated to a function of performing the movement of a mouse cursor. Keys ‘2’, ‘4’, ‘6’, and ‘8 ’ move the mouse cursor up, left, right, and down, respectively, and keys ‘1’, ‘3 ’, ‘7 ’, and ‘9 ’ move the mouse cursor upper left, upper right, lower left, and lower right, respectively. If the respective keys are pressed, the mouse cursor begins moving, and if the pressing of the keys is released, the movement of the mouse cursor is stopped. Further, when the keys are pressed, the mouse cursor moves slowly at first and then moves fast as time goes by, so that minute manipulation and manipulation for rapid movement are enabled at the same time.

Furthermore, when a computer screen is shrunk and displayed on the user terminal 120 or the number of updated screens per hour is limited due to the limit of the specification of the user terminal 120, the position of the mouse can jump from one position to another position. In this case, intermediate points between a point before movement and a point after movement are properly calculated on the computer side and then specified, so that the mouse can pass through the points. Accordingly, side effects occurring due to the jump of the mouse, such as a phenomenon where a button, which is activated only when the mouse passes over the button, does not react, etc. can be obviated.

A direction key region is allocated to assist the numeric keypad region. This method is more convenient because the numeric keypad region also supports the movement of a diagonal line, but cannot be used in a situation where menu selection, a character input and so on using a number are carried out. This necessitates an additional direction key region. The direction keys serve as the keys ‘2’, ‘4’, ‘6’, and ‘8 ’. When an OK key at the center is pressed, the list of functions provided by an individual, which is currently selected in the screen, is displayed as a menu. This is similar to the role of the right button of the mouse, of the input device of the computer. A function, which is most frequently used by users, of the list of the function is allocated to a 5 key of the numeric keypad region.

Therefore, the 5 key is similar to the role of the left button of the mouse. A Menu key is allocated to display the entire menu irrespective of an individual currently selected in the screen. A Cancel key is allocated to serve as the Esc key of the keyboard, and a Confirm key is allocated to serve as the OK key at the center of the direction key region or the 5 key of the numeric keypad region, if appropriate. A function of pressing the mouse button in a special form, such as shift-click, is provided as part of the menu, which appears when the OK key at the center is pressed.

By allocating the keys and the menu, transmitting corresponding inputs to the remote computer, converting the inputs to appropriate system events, and inputting converted inputs as described above, the mouse of the computer can be manipulated efficiently in the mobile phone.

Meanwhile, in the event that some regions of the computer screen are magnified to a predetermined magnification and displayed on the user terminal screen, a function of moving the screen to view other regions in addition to the movement of the mouse cursor is necessary. In this case, since a key for separately allocating the function is short, the mode of the numeric keypad region or the mode of the direction key region is switched. In the first mode, the movement of the mouse cursor is supported, and in the second mode, the movement of the screen is supported. At this time, the mode switch function can be allocated to a special key, such as * key or # under the numeric keypad region, or can be displayed as an additional menu. Thus, a user can magnify desired some of the computer screen and view displayed regions freely while moving.

In the case of a mouse cursor movement function and a screen movement function, if a moving command is reached additionally when the mouse cursor or some regions that are being displayed reach the edge of an actual screen, a function of automatically scrolling a window of the screen, which is currently displayed, and additionally showing other portions is preferably added.

Further, in the event that the window of the screen, which is currently displayed, can be scrolled, it is difficult to directly control and scroll a scroll bar using only the mouse cursor movement function and the click function. Thus, a function capable of immediately scrolling the window at the mouse positron, such as a mouse wheel, is needed. In this case, since there is no key to which this function will be allocated separately, the mode of the numeric keypad region or the direction key region is switched in the same manner as screen movement in order to support the function such as the mouse wheel.

The mode switch function is provided in the same manner as the screen movement function. Further, an actual mouse wheel is operated only up and down, but in this case, up, down, left, and right are all supported, so that the window can be easily scrolled horizontally. The scroll method is to control the scroll position of the window in the window of the known Windows. In the case of a web page, a scroll command is transferred to individuals that can be scrolled after checking them from an individual at a current mouse position to an individual at the highest position of an individual hierarchical structure.

Screen magnification and reduction are generally carried out using a volume increment key and a volume decrement key. However, since there is a case where corresponding keys do not exist according to a mobile phone, the keys are preferably added to the menu.

When a current screen is a web page, only a text of a current mouse position is extracted and displayed on the user terminal. Thus, only the text can be easily seen irrespective of a display method of an actual web page. This method is efficient when compared with a case where the entire web page is viewed as a text. This is because the text of the entire web page includes a great amount of decorations or menu texts as well as text information that is actually wanted by a user. In order to provide this function, a web individual of a current mouse position is found out through a Document Object Model (DOM), one individual of a hierarchical structure of a corresponding individual is then selected at an appropriate level, and a text contained in the individual is also extracted through the DOM.

For example, when an individual of a current position is an <P> individual, only a paragraph is extracted by extracting only a text of a corresponding individual. In the case of an article page, only some of the page is seen and a text of a patent individual of a corresponding individual is extracted accordingly. Things where not a corresponding individual, but the text of the patent individual is extracted as described above include <A>, <DIV>, <FONT>, <IMG>, <OL>, <P>, <SPAN>, <TR>, <UL> and the like. Subject individuals may be added or deleted according to a user s taste. At this time, in the individual <DIV>, a too large region is extracted if the text of a patent is extracted because <DIV> can be used instead of <TD> depending on a web page. To this end, assuming that <DIV> is used instead of <TD> when the patent of <DIV> is <DIV>, the text of the individual <DIV> is preferably extracted.

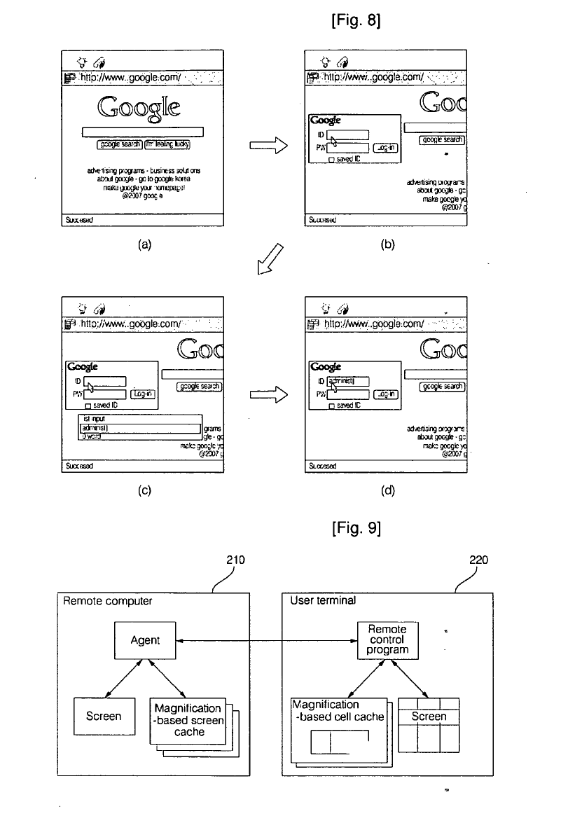

FIG. 8 is a view illustrating a method of performing the input of a character string and input object search.

A character string is input through an additional input window. A character string input menu item is provided as one of menu items. If a user selects the menu item, an additional input window is displayed on the screen. The user inputs a desired character string according to a general input method of a mobile phone by using the direction key region as a direction key and the numeric keypad region as a character input key. Since the additional input window is displayed, the user can use the numeric keypad region for the input of the character string without confusion.

The input character string can send the character string to a computer by pressing the OK key or the Confirm key at the center of the direction key region. At this time, only the character string may be sent or the character string to the end of which the Enter key is added may be sent. The Enter key functions to execute input results on most of one-line input windows displayed on the computer, so that a user can use an Enter key addition function. This can save trouble for a user to press an additional execution button displayed on the computer screen through manipulation of the mouse. By doing so, the user can control the keyboard of the computer efficiently through a limited input device of the user terminal.

If it is sought to input a character string, it is necessary to find out an individual though which the character string can be input in the computer screen and then select a selected individual. In the event that a character string is directly input in the computer, a corresponding individual can be selected using the mouse and then input using the keyboard in a simple way. However, in the event that the resolutions of a user terminal are not sufficient and therefore only part of the computer screen is magnified and seen, long time is taken to find out and select a corresponding individual. In order to solve such inconvenience, if a corresponding function is performed by using a special key, such as the * key or # key under the numeric keypad region, or providing a next input individual find function under the menu, a next input individual can be found out in the entire computer screen or an application program window that is currently selected, the individual can be displayed at an adequate location of a personal terminal screen, and a focus can be specified to a corresponding individual. In this case, a method of additionally providing a moving mode between input individuals to a mouse cursor movement mode and a screen moving mode can also be used in addition to the keys or the menu. By doing so, a user can use the above character string input function immediately.

It can be said that this function is similar to the function of the tap key of the computer. In the case of a web page, the tap key selects not only input individuals, but also hyperlinks. When a page includes lots of hyperlinks, a user cannot find out an input individual within a short time by using a method of supporting the tap key without change. Thus, in this function, when a subject that will be controlled currently is a web page, only an input individual is selectively selected by analyzing the DOM of the web page. Even in a general Windows screen, only individuals that seem to be important to a user are selected through Windows control analysis.

Therefore, in the control method in accordance with the present invention, not only simple screen capturing and input device emulation, but also programs and web pages that are used by a user are sensed and analyzed in order to extract screen control-related information. It is therefore possible to provide a user interface suitable for a current situation.

In the control method according to the present invention, in the method of efficiently transmitting screen data of a remote computer to a user terminal and displaying the screen data, only partial transmission of the screen, caching of the screen data, and transmission of the screen can be delayed.

Of them, the method of transmitting only part of the screen is useful when the screen resolutions of a general user terminal are lower than those of a remote computer. In this case, if it is sought to see the remote computer screen in the user terminal as its original size, it is inevitable to see only part of the screen. In this case, when only screen data of a region seen by a user is transmitted to the user terminal and updated and a seen region is changed, screen data of a corresponding region are sent to the user terminal again and then updated. Accordingly, remote control can be performed with only part of the entire screen data.

In the method of caching the screen data, the amount of data transmitted can be reduced and the memory use of the remote computer and the user terminal can be saved. A conventional remote control system is operated on the assumption that the user terminal can have the entire screen of the remote computer in its memory. However, in the control method according to the present invention, the fact that there may be a limit to the memory capacity of the user terminal is taken into consideration.

FIG. 9 is a view illustrating a construction of a screen data cache used in the control method in accordance with the present invention. A user terminal 220 can display the screen of a remote computer as several kinds of magnifications at the request of a user. A remote computer 210 captures the screen per magnification basis, which is requested by the user terminal 220. If data with respect to a region that is currently seen by the user terminal is changed, the remote computer 210 divides the changed portion per cell basis according to a magnification currently specified by the user terminal 220 and sends them to the user terminal. At this time, whether the data has been changed can be determined by comparing a screen cache per magnification basis and a current screen, which is divided on a cell basis.

If the remote computer 210 cannot have a screen cache for the entire magnifications in its memory at the same time because the types of magnifications requested by the user terminal 220 are too many, screen caches with respect to magnifications that have not been used for the longest time are deleted in order to secure the memory space. When the user terminal 220 requests screen data for a corresponding magnification subsequently, the remote computer 210 generates a new screen cache and operates as if the entire regions have been changed. The user terminal 220 caches the screen data as a magnification-based cell unit. A cell size is much smaller than the entire screen size. Even when the user terminal 220 does not have the entire screen data of the remote computer 210, part of the screen of the remote computer 210 can be displayed on the user terminal 220. In the same manner as the case of the remote computer 210, if memory is short enough to contain new cell data, the user terminal 220 secures the memory space by deleting a cell that has not been used for the longest time from its memory, and receives a corresponding cell from the remote computer for the purpose of a screen display by requesting it from the remote computer when the cell is necessary.

Accordingly, the remote computer 210 can receive a request for a cell that has not been changed after being sent to the user terminal 220. In this case, a corresponding cell must be sent to the user terminal again. On the other hand, when a cache is deleted from the remote computer 210, the user terminal 220 can receive a cell again, which has already been received. However, this is a rare case because the remote computer 210 has relatively sufficient memory.

As the remote computer 210 and the user terminal 220 manage cache separately as described above, a remote control system for minimizing the amount of transmission data, while considering a memory limit, can be provided. However, when the content of the screen is frequently changed in the remote computer 210, there is still a problem in that the amount of transmission data is great.

In the control method in accordance with the present invention, an increase of the amount of transmission data, which is caused by the amount of changed screen content, can be minimized by delaying transmission of screen data and then properly displaying a screen using data already existing in the user terminal during the delay period. In other words, the remote computer internally records a view region change request and a screen data request, which are received from the user terminal, without responding them directly, checks whether a screen has changed at a predetermined cycle, and sends requested data along with a screen part selected as a result of the check. At this time, if there is too many screen data to be sent since the screen has changed a lot, the remote computer can send part of the screen data and then send the remaining screen data after checking them again at a next cycle. The user terminal 220 displays the screen using already existing data, such as a cache, when the screen data arrives from the remote computer 210, and then displays the remaining screen when the screen data arrives later on.

Even in this case, the remote computer 210 can transmit screen data, which exceeds an amount that can be processed by the user terminal 220 per unit time due to the limits of a communication network speed and a processing speed of the user terminal 220. Accordingly, a cycle proceeds to a next cycle after receiving a response that the remote computer has received screen data from the user terminal at a predetermined cycle and has processed the received screen data. At this time, a transmission cycle and a transmission amount per cycle can be processed as user option inputs, or can be controlled automatically according to a data transmission rate during operation.

If transmission of the screen data is delayed as described above, it may be inconvenient since the screen of the user terminal 220 is not updated in real-time. However, such inconvenience can be offset by the advantage that an increase of the cost due to an excessive amount of transmission data and delay according to the limit of a communication network speed can be mitigated.

A method of transmitting user input information every given cycle without sending it in real-time may be used in addition to screen data transmission. If this method is used when a great amount of input data is generated in short bursts such as movement of a mouse cursor position, the amount of transmission data can be reduced significantly. In this case, user inconvenience due to delay can be minimized by previously displaying a change of the screen according to input data although transmission of actual input data is delayed.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

The present invention is used in a remote communication terminal with limited I/O device and limited memory capacity, and can control a computer at a remote place efficiently even in a communication network environment where the data transmission rate is limited and the transmission cost is high.

1. A control method of a system including a user terminal and a remote computer, which are connected to a communication network and can communicate with each other, the control method comprising the steps of: extracting screen data corresponding to a screen displayed on the remote computer, converting the extracted screen data according to a specification of the user terminal, and extracting screen control-related information of an application program that is being executed in the remote computer; allowing the user terminal to receive the converted screen data and the extracted screen control-related information; displaying a screen of the user terminal based on the received converted screen data and the received screen control-related information, receiving user input information on the basis of the displayed screen, and sending the received user input information to the remote computer; and allowing the remote computer to receive the user input information, convert the received user input information according to a specification of the remote computer, and drive a corresponding operation.

2. The control method of claim 1, wherein the user terminal comprises a mobile communication terminal that is accessible to the remote computer through a mobile communication network.

3. The control method of claim 2, wherein in the user terminal, keys included in a numeric keypad region are allocated to a function corresponding to movement of a mouse cursor, keys of a direction key region are allocated to a function to assist the numeric keypad region, a center key of the direction key region is allocated to a function for displaying, as a menu, a list of functions provided by an individual selected in a currently displayed screen, and a function that is most widely used, of the menu, is allocated to a ‘5 ’ key of the numeric keypad region.

4. The control method of claim 3, wherein in the user terminal, a menu key is allocated to a function for displaying an overall menu, a cancel key is allocated to a function corresponding to an Esc key of a keyboard, and a confirm key is further allocated so that the confirm key performs a function corresponding to a key at a center of the direction key region or a ‘5 ’ key of the numeric keypad region.

5. The control method of claim 3, wherein when the screen of the remote computer is reduced and displayed or a location of the mouse cursor is moved from one location to another location at a distance or more since the number of screen updated per unit time is limited in the user terminal, intermediate points between points before and after the movement are specified, and the mouse cursor is controlled to pass through the points.

6. The control method of claim 3, wherein when some regions of the screen of the remote computer are magnified as a predetermined magnification and displayed on the screen of the user terminal, for the purpose of a function for moving a currently displayed screen region other than the mouse cursor movement, the function of the numeric keypad region or the direction key region is switched between the mouse cursor movement function and a displayed screen region movement function using a ‘*’ key or ‘∩’ key or an additional menu.

7. The control method of claim 6, further comprising the step of, in the case of the mouse cursor movement function and the screen region movement function, if a moving command is input additionally when the mouse cursor or some regions that are currently displayed reach a boundary region of an actual screen, automatically scrolling a window of a currently displayed screen if the window can be scrolled and additionally displaying other parts.

8. The control method of claim 6, wherein when a window of a currently displayed screen can be scrolled, for the purpose of a function corresponding to a mouse wheel that can scroll a window at a location of the mouse cursor, the function of the numeric keypad region or the direction key region is switched between the mouse cursor movement, a screen region movement function, and a mouse wheel function using the ‘*’key or the ‘#’ key, or the additional menu.

9. The control method of claim 8, further comprising the step of providing a next input individual finding function by providing an input inter-individual movement function as a switchable state so that a subject through which a character string will be input is selected in the user terminal.

10. The control method of claim 8, wherein the mouse wheel function implements scroll by supporting movement of all directions including up, down, left, and right, controlling a scroll location of a window in a general Windows screen, and transferring a scroll command with respect to individuals that can be scrolled by checking the individuals from an individual at a current mouse cursor location to the highest place of an individual hierarchical structure in the case of a web page.

11. The control method of claim 2, wherein in the event that some regions of the screen of the remote computer are magnified as a predetermined magnification and then displayed on the screen of the user terminal, screen magnification and reduction are allocated to a volume increase key and a volume decrease key, respectively.

12. The control method of claim 2, further comprising the step of, when the screen of the remote computer is a web page, extracting a text of a current mouse cursor through a Document Object Module (DOM) and displaying the extracted text on the user terminal.

13 The control method of claim 12, further comprising the step of, in the event that the text is extracted through the DOM, in the case of individuals including <A>, <DIV>, <FONT>, <IMG>, <OL>, <P>, <SPAN>, <TR>, and <UL>, selecting a patent individual of the individuals, and when a patent of the individual <DIV> is <DIV>, extracting a text of the individual <DIV> itself.

14 The control method of claim 2, further comprising the step of, when a character string is input in the user terminal, displaying a character string input window on the screen, using keys of a numeric keypad region in a character input in the state where the character string input window is displayed, and if the character string input is finished and transmission is selected, transmitting only an input character string or automatically adding an Enter key to the last of the character string and sending the character string to which the Enter key is added.

15 The control method of claim 1, wherein:
when some regions of the screen of the remote computer are magnified as a predetermined magnification and then displayed on the screen of the user terminal, only a screen data corresponding to a region displayed on the screen of the user terminal is transmitted to the user terminal and then updated, and
when a viewing region is changed, screen data of a corresponding region is transmitted to the user terminal again and then updated, so that only part of a total screen data is transmitted and a task is performed.

16 The control method of claim 1, wherein the remote computer captures a screen on a magnification basis, which is requested by the user terminal, and when data of a region that is currently seen by the user terminal is changed, divides a changed part on a cell basis as a magnification currently specified in the user terminal and transmits the divided parts to the user terminal.

17 The control method of claim 16, wherein:
whether the data has been changed is determined by comparing a magnification-based screen cache and a current screen that is divided on a cell basis,
when a screen cache for the entire required magnifications cannot be stored, a screen cache for a magnification that has not bee used for the longest time is deleted to secure storage space, and
when screen data for a magnification from which the user terminal has been deleted is subsequently requested, a screen cache is newly generated.

18 The control method of claim 16, wherein:
caching is carried out as a magnification-based cell unit, which is requested in the user terminal,
a size of the cell unit is made smaller than that of a total screen so that part of the remote computer screen can be displayed on the user terminal even when the remote computer does not have a total screen data,
when storage space enough to contain new cell data is short, cells that have not been used for the longest time are deleted to secure storage space, and
if cells that have been deleted for screen display subsequently are requested, the cells are received again by requesting the cells from the remote computer.

19 The control method of claim 1, wherein:
the remote computer internally records a region change request and a screen data request, which are transferred from the user terminal, without directly responding to the requests, periodically checks whether the screen has been changed, and transmits requested data along with a screen part selected as a result of the check, and
when the requested screen data is a predetermined amount or more, the remote computer transmits only some of the screen data, checks the remaining screen data again at a next cycle and then transmits the remaining screen data, and proceeds to a next cycle after receiving a response that a process has been completed by receiving screen data at a predetermined cycle, if appropriate, from the user terminal, so that the remote computer controls an amount, which exceeds data that can be processed per unit time by the user terminal, not to be transmitted.

20 The control method of claim 1, wherein when a great amount of input data is generated in short bursts, the user terminal transmits the user input information at a predetermined cycle without transmitting the user input information in real-time in order to reduce an amount of transmission data.

21 The control method of claim 1, wherein even when the user input information has not been sent to the remote computer, the user input information has not been processed in a remote computer, or the user input information or screen change data has not been fully transmitted to the user terminal, the user terminal displays adjoining results using already existing user input information and screen data.

22 The control method of claim 1, further comprising the steps of:
displaying, on the user terminal, a user interface for controlling a computing environment generated in the remote computer; and
allowing the remote computer to control an operation requested through the user interface to be performed within the computing environment of the remote computer.

23 The control method of claim 22, further comprising the step of notifying the user terminal of the results of the operation requested by the remote computer.

24 The control method of claim 22, further comprising the step of allowing the remote computer to perform user certification according to a login request from the user terminal and then generate a computing environment corresponding to the user certification.

25 The control method of claim 22, wherein the user interface comprises at least one of a screen provided by the remote computer, a common menu for controlling an overall computing environment, and an individual menu for controlling an application program executed within the computing environment.

26 The control method of claim 22, wherein in the step of displaying the user interface, a plurality of computer environments are generated using one user account on an operating system and a desktop screen provided upon logon to the user account.

27 The control method of claim 26, wherein the remote computer stores a document of the application program and environment setting information in a user-unique space, and manages the document and the environment setting information using the one user account on the operating system so that a plurality of computing environments coexist.

28 The control method of claim 27, further comprising the step of logically dividing the screen of the remote computer according to screen resolutions of the user terminal, arranging a user interface for an application program of a computing environment corresponding to each logically partitioned part, and providing the user interface to the screen of the computing environment.

29 The control method of claim 28, wherein the remote computer reallocates a logical partition of a computing environment, which has not been used for the longest time, to a computing environment to which a logical partition must be allocated currently in order to provide computing environments having a number of possible logical partitions or more.

30 The control method of claim 22, further comprising the step of receiving a state, which has been changed according to a result of the requested operation, and a state that has been changed automatically in the computing environment from the user terminal, and reconfiguring the user interface.
